(19) United States
(12) Patent Application Publication
(10) Pub. No.: US 2024/0278221 A1
(43) Pub. Date: Aug. 22, 2024

(54) Catalyst for Hydrotreating Heavy Hydrocarbon Oil, Method for Producing Same, and Method for Hydrotreating Heavy Hydrocarbon Oil

(71) Applicant: JGC Catalysts and Chemicals Ltd., Kawasaki-shi (JP)

(72) Inventors: Kenji Yamane, Kitakyushu-shi, Fukuoka (JP); Hiroshi Shintaku, Kitakyushu-shi, Fukuoka (JP); Yusuke Matsumoto, Kitakyushu-shi, Fukuoka (JP)

(21) Appl. No.: 18/688,916

(22) PCT Filed: Sep. 5, 2022
(86) PCT No.: PCT/JP2022/033270

§ 371 Date: Mar. 4, 2024

(30) Foreign Application Priority Data
Sep. 6, 2021 (JP) 2021-144803

(51) Int. Cl. B01J 27/16; B01J 35/63; B01J 35/64; B01J 35/67; C10G 45/04

(52) U.S. Cl. CPC B01J 27/16; B01J 35/635; B01J 35/647; B01J 35/67; C10G 45/04

(57) ABSTRACT

[Problem] To provide a catalyst for hydrotreating a heavy hydrocarbon oil, the catalyst exhibiting excellent demetallization performance, desulfurization performance, and deasphaltene performance and having high strength. [Solution] A hydrotreating catalyst, which is a catalyst for hydrotreating a heavy hydrocarbon oil, the catalyst including an alumina-phosphorus oxide carrier, and a hydrogenation-active metal component supported on the carrier, in which the content of phosphorus in the carrier is 0.4 to 2.0 mass % in terms of P₂O₅, the carrier has a local maximum value of the differential pore volume distribution in a pore diameter range of 18 to 22 nm measured by mercury intrusion porosimetry, in the carrier, the ratio (ΔPV/PV_{T}) of a volume (ΔPV) of pores having a pore diameter in a range deviating from a range of a pore diameter at the local maximum value±2 nm to the total pore volume (PV_{T}) measured by mercury intrusion porosimetry is 0.50 or less, and the crystalline form of a portion of alumina in the alumina-phosphorus oxide carrier is γ-alumina.

### CROSS REFERENCE TO RELATED APPLICATIONS

This application is the United States national phase of International Patent Application No. PCT/JP2022/033270 filed Sep. 5, 2022, and claims priority to Japanese Patent Application No. 2021-144803 filed Sep. 6, 2021, the disclosures of which are hereby incorporated by reference in their entireties.

### BACKGROUND OF THE INVENTION

### Field of the Invention

The present invention relates to a catalyst for hydrotreating a heavy hydrocarbon oil, a method for producing the catalyst, and a method for hydrotreating a heavy hydrocarbon oil. More specifically, the present invention relates to a catalyst used for hydrotreating a heavy hydrocarbon oil such as a residual oil containing a metal contaminant such as an asphaltene, vanadium, or nickel, and a method for producing the catalyst, and relates to a hydrotreating method using the catalyst.

### Description of Related Art

In a process for pretreating a heavy hydrocarbon oil, deasphaltene performance is required in addition to high demetallization performance and desulfurization performance. Since an asphaltene is contained in a large amount in a heavy hydrocarbon oil and has a large molecular weight and also contains a large amount of metal, it is necessary to perform hydrotreatment when demetallization is performed to a high degree. In addition, when an asphaltene in a feedstock oil cannot be sufficiently hydrotreated in a process for hydrotreating a heavy hydrocarbon oil, a base material contains a large amount of dry sludge in a produced oil. Since a base material containing a large amount of dry sludge has low storage stability and causes various troubles, it is important to highly hydrotreat an asphaltene in a feedstock oil.

In order to hydrotreat an asphaltene having a large molecular weight, for example, a catalyst having enlarged pores, and a bimodal-type catalyst having two peaks in the differential pore volume distribution have been developed. In recent years, further improvement in performance is required for reducing the burden of R-FCC treatment after a hydrotreating process in order to cope with a further increase in the proportion of a heavy oil in a feedstock oil.

For example, Patent Literature 1 (i.e., JP 2006-181562 A) discloses a catalyst having high demetallization performance and desulfurization performance by forming a bimodal-type catalyst having mesopores in a range of 7 to 20 nm and macropores in a range of 300 to 800 nm.

For example, Patent Literature 2 (i.e., JP 2013-091010 A) discloses a catalyst having high demetallization performance and desulfurization performance by forming a catalyst having mesopores in a range of 10 to 30 nm.

For example, Patent Literature 3 (i.e., WO 2015/046316 A) discloses that a catalyst containing zinc in an amount of 1 to 15% based on a carrier and having an average pore size of 18 to 35 nm exhibits an effect of improving the storage stability of a produced oil while high desulfurization activity and demetallization performance are maintained.

### SUMMARY OF THE INVENTION

### Technical Problem

However, conventional catalysts for hydrotreating a heavy hydrocarbon oil have room for further improvement in terms of deasphaltene performance or the like.

In view of such a problem in the prior art, an object of the present invention is to provide a catalyst for hydrotreating a heavy hydrocarbon oil, the catalyst exhibiting excellent demetallization performance, desulfurization performance, and deasphaltene performance and having high strength, and a method for producing the catalyst.

### Solution to Problem

As a result of intensive studies, the present inventors found that the above-mentioned problem can be solved by using a carrier having a predetermined pore distribution, a predetermined composition, and a predetermined crystalline form, and completed the present invention.

The present invention relates to, for example, [1] to [9] below.

[1]

A hydrotreating catalyst, which is a catalyst for hydrotreating a heavy hydrocarbon oil,
the catalyst including an alumina-phosphorus oxide carrier, and a hydrogenation-active metal component supported on the carrier, wherein
the content of phosphorus in the carrier is 0.4 to 2.0 mass % in terms of P₂O₅,
the carrier has a local maximum value of the differential pore volume distribution in a pore diameter range of 18 to 22 nm measured by mercury intrusion porosimetry,
in the carrier, the ratio (ΔPV/PV_{T}) of a volume (ΔPV) of pores having a pore diameter in a range deviating from the range of a pore diameter at the local maximum value±2 nm to the total pore volume (PV_{T}) measured by mercury intrusion porosimetry is 0.50 or less, and
the crystalline form of a portion of alumina in the alumina-phosphorus oxide carrier is γ-alumina.
   [2]

The hydrotreating catalyst according to the above [1], wherein the differential pore volume distribution of the carrier is unimodal.

[3]

The hydrotreating catalyst according to the above [1] or [2], wherein the total pore volume (PV_{H2O}) measured by a pore-filling method with water is 0.65 to 1.00 ml/g.

[4]

The hydrotreating catalyst according to any one of the above [1] to [3], wherein phosphorus is contained in an amount of 1.0 to 5.0 mass % in terms of P₂O₅.

[5]

The hydrotreating catalyst according to any one of the above [1] to [4], wherein the hydrogenation-active metal component includes at least one metal selected from a group 6 metal and a group 8 metal of the periodic table.

[6]

The hydrotreating catalyst according to any one of the above [1] to [5], wherein the content of the hydrogenation-active metal component is 1 to 25 mass % in terms of an oxide of the metal contained in the hydrogenation-active metal component.

[7]

A method for producing a hydrotreating catalyst, which is a method for producing a catalyst for hydrotreating a heavy hydrocarbon oil, the method including:
a first step of adding a basic aluminum salt aqueous solution to an acidic aluminum salt aqueous solution with a pH adjusted to 2.0 to 6.0 to obtain a slurry with a pH of 9.7 to 10.5 containing hydrated alumina;
a second step of washing the hydrated alumina and adding water and a phosphorus component to the hydrated alumina after being washed to obtain a hydrate of alumina-phosphorus oxide;
a third step of calcining the hydrate of alumina-phosphorus oxide at 400 to 800° C. to obtain an alumina-phosphorus oxide carrier; and
a fourth step of supporting a hydrogenation-active metal component on the alumina-phosphorus oxide carrier to obtain a hydrotreating catalyst.
   [8]

The method for producing a hydrotreating catalyst according to the above [7], wherein the addition amount of the phosphorus component in the second step is such an amount that the content of phosphorus in the carrier obtained in the third step is 0.4 to 2.0 mass % in terms of P₂O₅.

[9]

A method for hydrotreating a heavy hydrocarbon oil, including a step of hydrotreating a heavy hydrocarbon oil in the presence of the hydrotreating catalyst of any one of the above [1] to [6].

### Advantageous Effects of Invention

The heavy hydrocarbon oil hydrotreating catalyst of the present invention has excellent demetallization performance, desulfurization performance, and deasphaltene performance, and also has high strength. Therefore, the catalyst is particularly effective for hydrotreating a heavy hydrocarbon oil. According to the production method of the present invention, a heavy hydrocarbon oil hydrotreating catalyst having such characteristics can be produced.

### BRIEF DESCRIPTION OF THE DRAWINGS

FIG. 1 is an integral pore distribution diagram of the catalyst A produced in Example 1.

FIG. 2 is a differential pore distribution diagram of the catalyst A produced in Example 1.

### DESCRIPTION OF THE INVENTION

### [Heavy Hydrocarbon Oil Hydrotreating Catalyst]

A heavy hydrocarbon oil hydrotreating catalyst (hereinafter also simply referred to as “hydrotreating catalyst” or “catalyst”) according to the present invention is a catalyst, in which a hydrogenation-active metal is supported on a carrier, and which meets the following requirements (1) to (4), and is used for hydrotreating a heavy hydrocarbon oil.

### Requirement (1): The Carrier is an Alumina-Phosphorus Oxide Carrier.

The carrier is an alumina-phosphorus oxide carrier. It is presumed that alumina-phosphorus oxide is a composite oxide of aluminum and phosphorus. The alumina-phosphorus oxide carrier may contain only alumina and phosphorus oxide, or may additionally contain an inorganic oxide such as silica, boria, titania, or zirconia. From the viewpoint of maintaining the strength of the carrier and reducing the production cost, the carrier contains aluminum in an amount of preferably 65 mass % or more, and more preferably 75 mass % or more in terms of alumina based on the total amount of the carrier.

The carrier contains phosphorus in an amount of 0.4 to 2.0 mass %, and preferably 0.5 to 1.4 mass % in terms of P₂O₅ based on the total amount of the carrier. It is not preferable that the phosphorus content is less than 0.4 mass % because the catalyst strength (abrasion resistance) decreases. It is not preferable that the phosphorus content is more than 2.0 mass % because the pore diameter of the catalyst, specifically, the pore diameter at the local maximum value described below becomes small.

### Requirement (2): The Carrier has a Local Maximum Value of the Differential Pore Volume Distribution in a Pore Diameter Range of 18 to 22 nm.

The carrier has a local maximum value of the differential pore volume distribution in a pore diameter range of 18 to 22 nm in a pore distribution measured by mercury intrusion porosimetry. It is not preferable that the local maximum value is in a pore diameter range of less than 18 nm because the demetallization performance of the catalyst significantly deteriorates, and also it is not preferable that the local maximum value is in a pore diameter range of more than 22 nm, because the desulfurization performance of the catalyst tends to deteriorate.

The details of the measurement method are as follows.

About 3 g of a measurement sample is collected in a porcelain crucible, heated at a temperature of 500° C. for 1 hour, then placed in a desiccator and cooled to room temperature to obtain a sample for measurement, and then the pore distribution is measured by mercury intrusion porosimetry (contact angle of mercury: 150°, surface tension: 480 dyn/cm).

Requirement (3): The Ratio (ΔPV/PV_{T}) of the Volume (ΔPV) of Pores Having a Pore Diameter in a Range Deviating from the Pore Diameter at the Local Maximum Value±2 nm to the Total Pore Volume (PV_{T}) is 0.50 or Less.

In the catalyst according to the present invention, the ratio (ΔPV/PV_{T}) of the volume (ΔPV) of pores having a pore diameter in a range deviating from the range of the pore diameter at the local maximum value (that is, the pore diameter at which the differential pore volume distribution becomes maximum within a pore diameter range of 18 to 22 nm measured by mercury intrusion porosimetry)+2 nm to the total pore volume (PV_{T}) measured by mercury intrusion porosimetry is 0.50 or less, preferably 0.46 or less, and more preferably 0.45 or less. It is not preferable that ΔPV/PV_{T} excessively exceeds 0.50 because the reactivity between the catalyst and the asphaltene molecule deteriorates, and the demetallization performance and the deasphaltene performance deteriorate. The lower limit of ΔPV/PV_{T} is, for example, about 0.41.

### Requirement (4): The Crystalline Form of a Portion of Alumina in the Alumina-Phosphorus Oxide Carrier is γ-Alumina.

When the crystalline form of the portion of alumina in the alumina-phosphorus oxide forming the carrier is γ-alumina, the number of surface hydroxy groups required for supporting the active metal component on the alumina-phosphorus oxide carrier is large, and the catalyst exhibits high desulfurization activity. On the other hand, when the crystalline form is α-alumina or θ-alumina, the number of surface hydroxy groups required for supporting the active metal component on the alumina-phosphorus oxide carrier is small, and high desulfurization activity cannot be expected. A very small portion of the alumina portion may have a crystalline form other than γ-alumina (for example, α-alumina or θ-alumina) as long as the effect of the present invention is not impaired.

The catalyst according to the present invention preferably meets any one or more of the following requirements (5) to (9).

### Requirement (5): The Differential Pore Volume Distribution of the Carrier is Unimodal.

In the catalyst according to the present invention, the differential pore volume distribution of the carrier is unimodal.

Requirement (6): The Specific Surface Area of the Catalyst is 100 m²/g or More.

The catalyst according to the present invention has a specific surface area measured by a BET method of 100 m²/g or more, preferably 140 to 220 m²/g. When the specific surface area is equal to or more than the above-mentioned lower limit, the desulfurization reaction rate is high. When the specific surface area is equal to or less than the above-mentioned upper limit, the demetallization property (demetallization selectivity) and the stability of catalytic activity are excellent. The specific surface area can be increased or decreased, for example, by changing a calcining temperature or a calcining atmosphere.

Requirement (7): The Total Pore Volume (PV_{H2O}) of the Catalyst Measured by a Pore-Filling Method with Water is in a Range of 0.65 to 1.00 ml/g.

The catalyst according to the present invention has a total pore volume (PV_{H2O}) measured by a pore-filling method with water in a range of 0.65 to 1.00 ml/g, preferably 0.68 to 0.95 ml/g, and more preferably 0.70 to 0.90 ml/g. When the total pore volume (PV_{H2O}) is equal to or more than the above-mentioned lower limit, the life of demetallization performance is long. When the total pore volume (PV_{H2O}) is equal to or less than the above-mentioned upper limit, the catalyst strength is high.

### Requirement (8): The Pressure Resistance Strength of the Catalyst is 10 N/Mm or More.

The pressure resistance strength (also referred to as crushing strength) of the catalyst according to the present invention measured with a Kiya hardness tester is 10 N/mm or more. When the pressure resistance strength is equal to or more than the above-mentioned lower limit, the catalyst is difficult to break when the catalyst is loaded, and it is possible to prevent a drift or a pressure loss during the reaction.

Requirement (9): The Hydrogenation-Active Metal is at Least One Metal Selected from a Group 6 Metal and a Group 8 Metal of the Periodic Table.

In the catalyst according to the present invention, the hydrogenation-active metal to be supported is at least one metal selected from a group 6 metal and a group 8 metal of the periodic table.

As the metal to be supported on the carrier, it is preferable to use the above-mentioned group 6 metal and group 8 metal of the periodic table in combination from the viewpoint of reactivity. The group 6 metal is preferably molybdenum and tungsten, and the group 8 metal is preferably nickel and cobalt.

The supported amount of the hydrogenation-active metal (the amount of the catalyst is taken as 100 mass %) is preferably 1 to 25 mass % and more preferably 5 to 16 mass % in terms of an oxide of a hexavalent metal in the case of a group 6 metal of the periodic table, and is preferably 0.1 to 10 mass % and more preferably 0.3 to 5 mass % in terms of an oxide of a divalent metal in the case of a group 8 metal of the periodic table. It is preferable that the supported amount of the metal is equal to or less than the above-mentioned upper limit from the viewpoint of demetallization property (demetallization selectivity), stability of catalytic activity, and reduction in production cost.

### [Method for Producing Heavy Hydrocarbon Oil Hydrotreating Catalyst]

The method for producing a heavy hydrocarbon oil hydrotreating catalyst of the present invention includes first to fourth steps described below.

### [Method for Producing Alumina-Phosphorus Oxide Carrier]

### (First Step: Step of Obtaining Hydrated Alumina)

The first step is a step of adding a basic aluminum salt aqueous solution to an acidic aluminum salt aqueous solution with a pH adjusted to 2.0 to 6.0 to obtain a slurry with a pH of 9.7 to 10.5 containing hydrated alumina.

The acidic aluminum salt may be any water-soluble salt, and examples thereof include aluminum sulfate, aluminum chloride, aluminum acetate, and aluminum nitrate, and among these, aluminum sulfate is preferable. The acidic aluminum salt aqueous solution contains an acidic aluminum salt in an amount of preferably 1 to 15 mass % and more preferably 2 to 10 mass % in terms of Al₂O₃.

Subsequently, a basic aluminum salt aqueous solution is added to the acidic aluminum salt aqueous solution with a pH of 2.0 to 6.0. The basic aluminum salt may be any water-soluble salt, and examples thereof include sodium aluminate and potassium aluminate.

This addition is usually performed while the acidic aluminum salt aqueous solution is stirred.

The basic aluminum salt aqueous solution is usually added over 30 to 200 minutes, preferably 60 to 180 minutes.

The basic aluminum salt aqueous solution contains a basic aluminum salt in an amount of preferably 5 to 35 mass % and more preferably 10 to 30 mass % in terms of Al₂O₃.

The addition of the basic aluminum salt aqueous solution is performed so as to obtain a slurry containing hydrated alumina and having a pH of 9.7 to 10.5. When the pH is less than 9.7, ΔPV/PV_{T} of the obtained carrier tends to increase, and when the pH is more than 10.5, the local maximum value of the carrier pore diameter tends to decrease.

In addition, it is desirable to perform the first step so that the obtained slurry contains hydrated alumina in an amount of 5.0 to 9.0 mass %, preferably 6.0 to 8.0 mass % in terms of Al₂O₃.

### (Second Step: Step of Obtaining Hydrate of Alumina-Phosphorus Oxide)

The second step is a step of washing the hydrated alumina obtained in the first step, and adding water and a phosphorus component to the hydrated alumina after being washed to obtain a hydrate of alumina-phosphorus oxide.

The hydrated alumina obtained in the first step is washed with pure water usually at 50 to 80° C., preferably at 60 to 70° C. to remove impurities such as sodium and sulfate radicals, thereby obtaining a washed cake.

The addition of water and the phosphorus component to the washed cake, that is, the hydrated alumina after being washed, is usually performed by adding water (usually pure water) to the washed cake to prepare a slurry so that the Al₂O₃ concentration is 5 to 16 mass %, preferably 7 to 14 mass %, and then adding the phosphorus component to the slurry. In this manner, a slurry of a hydrate of alumina-phosphorus oxide is obtained.

The phosphorus component is added so that phosphorus is contained in an amount of preferably 0.4 to 2.0 mass %, and more preferably 0.5 to 1.4 mass % in terms of P₂O₅ in the carrier to be obtained.

Examples of the phosphorus component include phosphoric acid compounds such as phosphoric acid, phosphorous acid, ammonia phosphate, potassium phosphate, and sodium phosphate, and among these, phosphoric acid is preferable.

### (Third Step: Step of Obtaining Alumina-Phosphorus Oxide Carrier)

The third step is a step of calcining the hydrate of alumina-phosphorus oxide obtained in the second step at 400 to 800° C. to obtain an alumina-phosphorus oxide carrier.

In the third step, usually, the slurry of the hydrate of alumina-phosphorus oxide obtained in the second step is aged, then dehydrated, the dehydrated material is kneaded, the kneaded material is shaped into a desired shape and dried, and then the shaped material is calcined to obtain an alumina-phosphorus oxide carrier.

The aging is usually performed in an aging tank with a reflux device.

The aging is usually performed at 30° C. or higher, preferably 80 to 100° C., and usually for 1 to 20 hours, preferably 2 to 10 hours.

The dehydration of the aged slurry and the kneading of the dehydrated material can be performed by a conventionally known method. The dehydrated material is concentrated and kneaded by, for example, steam heating using a double arm kneader with a steam jacket until the water content reaches a predetermined amount.

The shaping of the kneaded material can be performed by a conventionally known method such as extrusion molding.

The drying of the molded material is usually performed at 90 to 130° C. for 15 minutes to 14 hours.

The calcining of the molded material is performed at 400 to 800° C., preferably 500 to 700° C., and usually over 0.5 to 10 hours.

Examples of the shape of the molded material include a cylinder shape, a three leaf shape, and a four leaf shape.

### [Method for Supporting Metal on Carrier]

The fourth step is a step of supporting a hydrogenation-active metal component (hereinafter, also referred to as “metal component raw material”) on the alumina-phosphorus oxide carrier obtained in the third step to obtain a hydrotreating catalyst.

In the fourth step, usually, a metal component raw material is supported on the alumina-phosphorus oxide carrier obtained in the third step, and then the alumina-phosphorus oxide carrier on which the metal component raw material is supported is calcined to obtain a hydrotreating catalyst in which a hydrogenation-active metal component is supported on the alumina-phosphorus oxide carrier.

The metal component raw material is supported on the alumina-phosphorus oxide carrier, for example, by preparing an impregnation liquid containing the metal component raw material, an acid, and water by, for example, a well-known method such as an impregnation method or an immersion method, and impregnating the alumina-phosphorus oxide carrier with the impregnation liquid.

Examples of the metal component raw material include metal compounds such as nickel nitrate, nickel carbonate, cobalt nitrate, cobalt carbonate, molybdenum trioxide, ammonium molybdate, and ammonium paratungstate.

The blending amount of each metal component raw material is set so that the amount of the hydrogenation-active metal component in the hydrotreating catalyst to be produced falls within the above-mentioned range.

The impregnation liquid is prepared, for example, by suspending a metal component raw material in water, and adding an acid thereto to dissolve the metal component raw material.

Examples of the acid include an inorganic acid and an organic acid.

Examples of the inorganic acid include phosphoric acids and nitric acid, and examples of the phosphoric acids include phosphoric acid, ammonium dihydrogen phosphate, diammonium hydrogen phosphate, trimetaphosphoric acid, pyrophosphoric acid, and tripolyphosphoric acid.

Examples of the organic acid include citric acid, malic acid, tartaric acid, acetic acid, ethylenediaminetetraacetic acid (EDTA), and diethylenetriaminepentaacetic acid (DTPA).

Among these, phosphoric acid and citric acid are preferable.

The impregnation of the alumina-phosphorus oxide carrier with the impregnation liquid is performed, for example, by spraying the impregnation liquid onto the alumina-phosphorus oxide carrier.

The alumina-phosphorus oxide carrier (hereinafter also referred to as “raw material-supporting carrier”) on which the metal component raw material is supported is preferably dried and then calcined to obtain a hydrotreating catalyst in which a hydrogenation-active metal component is supported on the alumina-phosphorus oxide carrier.

The drying of the raw material-supporting carrier is performed usually at 200 to 300° C. and usually over 0.5 to 2.0 hours.

The calcining of the raw material-supporting carrier is performed usually at 400 to 600° C. and usually over 0.5 to 5 hours.

The above-mentioned hydrotreating catalyst according to the present invention can be produced by the method for producing a hydrotreating catalyst according to the present invention.

According to the production method of the present invention, it is possible to obtain a catalyst including a carrier having a local maximum value of the differential pore volume distribution in a pore diameter range of 18 to 22 nm and a low ΔPV/PV_{T} value by obtaining a slurry of hydrated alumina so that the pH is 9.7 to 10.5 in the first step, adding phosphorus to the carrier in an amount of 0.4 to 2.0 mass % in terms of P₂O₅ based on the total amount of the carrier in the second step, and the like. In addition, the strength and desulfurization activity of the catalyst can be improved by adding phosphorus to the carrier. When the amount of phosphorus is not within the above-mentioned range, the strength of the catalyst may decrease or the desulfurization activity may decrease.

In addition, hydrated alumina particles having a large crystallite diameter are prepared by adding a basic aluminum salt aqueous solution to an acidic aluminum salt aqueous solution. It is considered that the phosphorus component added to the hydrated alumina particles after the by-product salt is removed plays a role as an inorganic crosslinking agent for the hydrated alumina. After the phosphorus component is added, for example, aging, kneading, molding, drying, calcining are sequentially performed to obtain an alumina-phosphorus oxide carrier having the local maximum value in a pore diameter range of 18 to 22 nm.

Further, the SO₄ concentration in the alumina-phosphorus oxide carrier is desirably set to 1 mass % or less. The carrier produced so as to have a SO₄ concentration of 1 mass % or less does not have an excessively small pore size and has high strength.

The hydrotreating catalyst composition of the present invention is suitably used for hydrotreating, particularly demetallizing a heavy hydrocarbon oil such as a residual oil containing a metal contaminant such as vanadium or nickel, and an existing hydrotreating apparatus and operating conditions thereof can be adopted.

In addition, the production of the present composition is simple, and therefore, the productivity is also high, and the present composition is also advantageous in terms of production cost.

### EXAMPLES

Hereinafter, the present invention will be specifically described with reference to examples, but the present invention is not limited thereto.

### [Measurement Method]

### <Method for Measuring Contents of Carrier Components (Aluminum and Phosphorus) and Metal Components (Molybdenum and Nickel)>

About 10 g of a measurement sample was ground in a mortar, and then about 0.5 g of the ground sample was collected, subjected to a heat treatment (200° C., 20 min), and calcined (700° C., 5 min). Then, 2 g of Na₂O₂ and 1 g of NaOH were added thereto, followed by melting for 15 minutes. Further, 25 ml of H₂SO₄ and 200 ml of water were added thereto to dissolve the material to be dissolved, followed by dilution with pure water to 500 ml to prepare a sample. With respect to the obtained sample, the content of each component other than aluminum in terms of oxide was measured using an ICP emission spectrometer (ICPS-8100, analysis software ICPS-8000, manufactured by SHIMADZU CORPORATION). The aluminum content (in terms of Al₂O₃) was determined as a value obtained by subtracting the contents of other components from the amount of the measurement sample.

### <Method for Measuring Content of Sulfate Ions>

The content of sulfate ions in the carrier was measured by a combustion method with a sulfur analyzer (CS844, manufactured by LECO Corporation) using a previously ground measurement sample.

### <Method for Measuring Differential Pore Volume Distribution of Carrier>

About 3 g of a measurement sample was collected in a porcelain crucible, heated at a temperature of 500° C. for 1 hour, then placed in a desiccator and cooled to room temperature to obtain a sample for measurement, and then the differential pore volume distribution was measured by mercury intrusion porosimetry (PoreMaster GT-60, manufactured by Quantachrome Corporation, contact angle of mercury: 150°, surface tension: 480 dyn/cm).

### <Method for Measuring Pore Volume of Carrier>

About 30 g of a measurement sample was collected in a porcelain crucible, heated at a temperature of 500° C. for 1 hour, then placed in a desiccator and cooled to room temperature to obtain a sample for measurement, and then the pore volume was measured by a pore-filling method with water.

### <Method for Measuring Pressure Resistance Strength of Carrier>

The pressure resistance strength of the carrier was measured with a Kiya hardness tester.

### <Method for Checking Crystalline Form of Alumina>

The measurement sample was ground in a mortar and then compacted on a non-reflective plate for measurement to prepare an observation sample, and the crystalline form was checked using an X-ray diffractometer (RINT-2100, manufactured by Rigaku Corporation).

### Example 1

### (Production of Carrier)

A tank provided with a circulation line having two chemical solution addition ports was charged with 68.4 kg of pure water, and 42.6 kg of an aluminum sulfate aqueous solution (concentration of 7 mass % in terms of Al₂O₃) was added thereto under stirring, and the mixture was heated to 60° C. and circulated. At this time, the pH of the aluminum sulfate aqueous solution was 2.3.

Subsequently, 31.9 kg of a sodium aluminate aqueous solution (concentration of 22 mass % in terms of Al₂O₃) was added to the aluminum sulfate aqueous solution over 90 minutes while the temperature was maintained at 60° C. under stirring and circulating, thereby obtaining a slurry a of hydrated alumina (concentration of 7.0 mass % in terms of Al₂O₃). The pH of the obtained slurry a was 10.0.

Subsequently, the obtained hydrated alumina was separated by filtration and washed with pure water at 60° C. to remove impurities such as sodium and sulfate radicals, thereby obtaining a washed cake. Pure water was added to the washed cake to prepare a slurry so as to have an Al₂O₃ concentration of 10 mass %, then 164 g (concentration of 62 mass % in terms of P₂O₅) of phosphoric acid was added to the slurry, and the slurry was aged at 95° C. for 3 hours in an aging tank equipped with a reflux device.

The slurry after completion of aging was dehydrated, and the obtained dehydrated material was concentrated and kneaded to a predetermined water amount while kneading with a double-arm kneader provided with a steam jacket. The obtained kneaded material was extrusion-molded into a 1.7 mm four-leaf columnar shape with an extrusion molding machine. The obtained molded product was dried at 110° C. for 12 hours and then further calcined at 600° C. for 3 hours to obtain an alumina-phosphorus oxide carrier a.

The carrier a contained phosphorus in an amount of 1 mass % in terms of P₂O₅ and aluminum in an amount of 99 mass % in terms of Al₂O₃ (the total amount of the carrier is taken as 100 mass %).

### (Production of Catalyst)

In 400 ml of ion exchanged water, 59.4 g of molybdenum oxide and 22.7 g of nickel carbonate were suspended, and this suspension was heated at 95° C. for 5 hours with an appropriate reflux device so as not to reduce the liquid volume, and then 36.7 g of phosphoric acid was added thereto to dissolve the components, thereby preparing an impregnation liquid. After 500 g of the carrier a was impregnated with this impregnation liquid by spraying, the carrier a was dried at 250° C. and further calcined at 550° C. for 1 hour in an electric furnace, thereby obtaining a hydrotreating catalyst A (hereinafter also simply referred to as “catalyst A”, the same applies to the following examples).

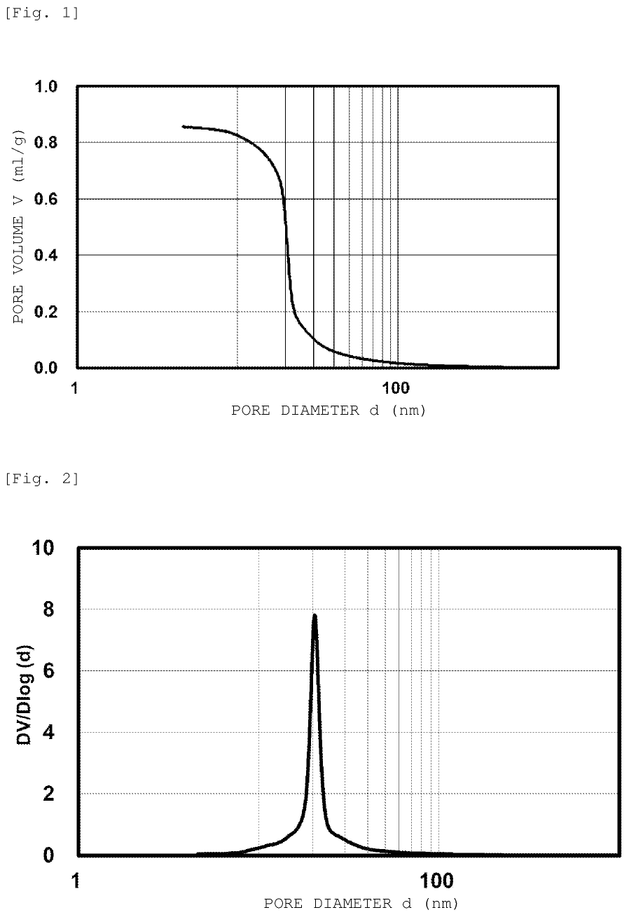

The catalyst A contained molybdenum in an amount of 10 mass % in terms of MoO₃ and nickel in an amount of 2.1 mass % in terms of NiO (the total amount of the catalyst is taken as 100 mass %). The properties of the catalyst A are shown in Table 1. FIGS. 1(A) and 1(B) show integral and differential pore distribution diagrams of the hydrotreating catalyst A, respectively.

### Example 2

An alumina-phosphorus oxide carrier b was obtained in the same manner as in “Production of carrier” in Example 1 except that the addition amount of phosphoric acid was changed to 131 g. The carrier b contained phosphorus in an amount of 0.8 mass % in terms of P₂O₅ and aluminum in an amount of 99.2 mass % in terms of Al₂O₃.

Subsequently, a catalyst B was obtained in the same manner as in “Production of catalyst” in Example 1 except that the carrier a was changed to the carrier b. The properties of the catalyst B are shown in Table 1.

### Example 3

An alumina-phosphorus oxide carrier c was obtained in the same manner as in “Production of carrier” in Example 1 except that the addition amount of phosphoric acid was changed to 197.2 g. The carrier c contained phosphorus in an amount of 1.2 mass % in terms of P₂O₅ and aluminum in an amount of 98.8 mass % in terms of Al₂O₃.

Subsequently, a catalyst C was obtained in the same manner as in “Production of catalyst” in Example 1 except that the carrier a was changed to the carrier c. The properties of the catalyst C are shown in Table 1.

### Example 4

A hydrotreating catalyst D was obtained in the same manner as in “Production of catalyst” in Example 1 except that the addition amounts of molybdenum oxide, nickel carbonate, and phosphoric acid were changed to 73.1 g, 32.1 g and 32.9 g, respectively.

The catalyst D contained 12 mass % in terms of MoO₃ and 3.2 mass % in terms of NiO. The properties of the catalyst D are shown in Table 1.

### Comparative Example 1

An alumina carrier e was obtained in the same manner as in “Production of carrier” in Example 1 except that phosphoric acid was not added in Example 1.

Subsequently, a catalyst E was obtained in the same manner as in “Production of catalyst” in Example 1 except that the carrier a was changed to the carrier e. The properties of the catalyst E are shown in Table 1.

### Comparative Example 2

An alumina-phosphorus oxide carrier f was obtained in the same manner as in “Production of carrier” in Example 1 except that the addition amount of phosphoric acid was changed to 416.4 g. The carrier f contained phosphorus in an amount of 2.5 mass % in terms of P₂O₅ and aluminum in an amount of 97.5 mass % in terms of Al₂O₃.

Subsequently, a catalyst F was obtained in the same manner as in “Production of catalyst” in Example 1 except that the carrier a was changed to the carrier f. The properties of the catalyst F are shown in Table 1.

### Comparative Example 3

An alumina-phosphorus oxide carrier g was obtained in the same manner as in “Production of carrier” in Example 1 except that the addition amount of phosphoric acid was changed to 502.2 g. The carrier g contained phosphorus in an amount of 3.0 mass % in terms of P₂O₅ and aluminum in an amount of 97.0 mass % in terms of Al₂O₃.

Subsequently, a catalyst G was obtained in the same manner as in “Production of catalyst” in Example 1 except that the carrier a was changed to the carrier g. The properties of the catalyst G are shown in Table 1.

### Comparative Example 4

An alumina-phosphorus oxide carrier h was obtained in the same manner as in “Production of carrier” in Example 1 except that the neutralization balance between the aluminum sulfate aqueous solution and the sodium aluminate aqueous solution in Example 1 was changed, thereby setting the pH after the addition to 9.3 when hydrated alumina was obtained. The carrier h contained phosphorus in an amount of 1 mass % in terms of P₂O₅ and aluminum in an amount of 99 mass % in terms of Al₂O₃.

Subsequently, a catalyst H was obtained in the same manner as in “Production of catalyst” in Example 1 except that the carrier a was changed to the carrier h. The properties of the catalyst H are shown in Table 1.

### Comparative Example 5

A tank provided with a circulation line having two chemical solution addition ports was charged with 68.4 kg of pure water, and 31.9 kg of a sodium aluminate aqueous solution (concentration of 22 mass % in terms of Al₂O₃) was added thereto under stirring, and the mixture was heated to 60° C. and circulated. At this time, the pH of the sodium aluminate aqueous solution was 13.4.

Subsequently, 42.6 kg of an aluminum sulfate salt aqueous solution (concentration of 7 mass % in terms of Al₂O₃) was added to the sodium aluminate aqueous solution over 90 minutes while the temperature was maintained at 60° C. under stirring and circulating, thereby obtaining a slurry i of hydrated alumina. The pH of the obtained slurry i was 10.0.

An alumina-phosphorus oxide carrier i was obtained in the same manner as in “Production of carrier” in Example 1 except that the slurry a was changed to the slurry i.

The carrier i contained phosphorus in an amount of 1.0 mass % in terms of P₂O₅ and aluminum in an amount of 99.0 mass % in terms of Al₂O₃.

Subsequently, a catalyst I was obtained in the same manner as in “Production of catalyst” in Example 1 except that the carrier a was changed to the carrier i. The properties of the catalyst I are shown in Table 1.

### Comparative Example 6

An alumina-phosphorus oxide carrier j was obtained in the same manner as in “Production of carrier” in Comparative Example 5 except that calcining was performed at an alumina carrier calcining temperature of 1050° C. to change the alumina form to 0-alumina in Comparative Example 6. The carrier j contained phosphorus in an amount of 1 mass % in terms of P₂O₅ and aluminum in an amount of 99 mass % in terms of Al₂O₃.

Subsequently, a catalyst J was obtained in the same manner as in “Production of catalyst” in Example 1 except that the carrier a was changed to the carrier j. The properties of the catalyst J are shown in Table 1.

### [Catalytic Activity Evaluation Test]

With respect to the catalysts A to D of Examples 1 to 4 and the catalysts E to J of Comparative Examples 1 to 6, hydrodemetallization activity, desulfurization activity, and deasphaltene activity were examined under the following conditions using a fixed bed microreactor.

A commercially available demetalization catalyst, an example catalyst, or a comparative example catalyst, and a commercially available desulfurization catalyst were loaded in a fixed bed flow type reactor (catalyst loading volume: 350 ml) in the following order.
35 ml of a commercially available demetalization catalyst CDS-RS110 (manufactured by JGC Catalysts and Chemicals Ltd.)
70 ml of a commercially available demetalization catalyst CDS-RS210 (manufactured by JGC Catalysts and Chemicals Ltd.)
105 ml of an example catalyst or a comparative example catalyst,
140 ml of a commercially available desulfurization catalyst CDS-R38C (manufactured by JGC Catalysts and Chemicals Ltd.)
Reaction conditions;
Catalyst loading amount: 350 ml
Reaction pressure: 13.5 MPa
Liquid hourly space velocity (LHSV): 1.0 hr⁻¹
Hydrogen/oil ratio (H₂/HC): 800 Nm³/kl
Reaction temperature: 370° C.

As the feedstock oil, atmospheric residual oil having the following properties was used.
Properties of feedstock oil;
Density (15° C.): 0.974 g/cm³
Asphalthene content: 4.2 mass %
Sulfur content: 4.020 mass %
Amount of metals (Ni+V): 86 mass ppm

The hydrodemetallization activity, desulfurization activity, and deasphaltene activity were expressed as a demetallization rate, a desulfurization rate, and a deasphaltene rate, and the values are shown in Table 1.

The demetallization rate was determined by the following formula.

$$Demetallization rate = ( metal concentration in feedstock oil - metal concentration in hydrotreated product oil ) / metal concentration in feedstock oil \times 100$$

The desulfurization rate was determined by the following formula.

$$Desulfurization rate = ( sulfur concentration in feedstock oil - sulfur concentration in hydrotreated product oil ) / sulfur concentration in feedstock oil \times 100$$

The deasphaltene rate was determined by the following formula.

$$Deasphaltene rate = ( asphaltene concentration in feedstock oil - sulfur concentration in hydrotreated product oil ) / asphaltene concentration in feedstock oil \times 100$$

TABLE 1

| | | Example 1 | Example 2 | Example 3 | Example 4 |
|---|---|---|---|---|---|
| Carrier | | | | | |
| Type | | a | b | c | a |
| Amount of P₂O₅ | mass % | 1.0% | 0.8% | 1.2% | 1.0% |
| Crystalline form of alumina | | γ-alumina | γ-alumina | γ-alumina | γ-alumina |
| Amount of SO₄ | mass % | 0.6 | 0.6 | 0.7 | 0.6 |
| Local maximum PD (*1) | nm | 21 | 20 | 19 | 21 |
| ΔPV/PV_{T} (*2) | % | 0.43 | 0.45 | 0.44 | 0.43 |
| Second peak (*3) | | Absent | Absent | Absent | Absent |
| Catalyst | | | | | |
| Type | | A | B | C | D |
| Supported amount of metal | mass % | MoO₃/NiO | MoO₃/NiO | MoO₃/NiO | MoO₃/NiO |
| | | 10/2.1 | 10/2.1 | 10/2.1 | 12/2.9 |
| Specific surface area | m²/g | 161 | 158 | 164 | 157 |
| PV_{H2O} | ml/g | 0.76 | 0.78 | 0.75 | 0.75 |
| Pressure resistance strength | N/mm | 12.9 | 11.9 | 12.2 | 13.0 |
| Amount of P₂O₅ | mass % | 4.7 | 4.5 | 4.9 | 3.9 |
| Catalytic activity evaluation | | | | | |
| Demetallization rate | % | 84% | 84% | 84% | 82% |
| Desulfurization rate | % | 88% | 87% | 89% | 87% |
| Deasphaltene rate | % | 81% | 81% | 80% | 78% |

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Carrier | | | | | | | |
| Type | | e | f | g | h | i | j |
| Amount of P₂O₅ | mass % | 0.0% | 2.5% | 3.0% | 1.0% | 1.0% | 1.0% |
| Crystalline form of alumina | | γ-alumina | γ-alumina | γ-alumina | γ-alumina | γ-alumina | θ-alumina |
| Amount of SO₄ | mass % | 0.6 | 0.6 | 0.6 | 1.7 | 0.8 | 0.8 |
| Local maximum PD (*1) | nm | 18 | 17 | 16 | 17 | 15 | 22 |
| ΔPV/PV_{T} (*2) | % | 0.47 | 0.52 | 0.57 | 0.51 | 0.56 | 0.38 |
| Second peak (*3) | | Absent | Absent | Present | Absent | Absent | Absent |
| Catalyst | | | | | | | |
| Type | | E | F | G | H | I | J |
| Supported amount of metal | mass % | MoO₃/NiO | MoO₃/NiO | MoO₃/NiO | MoO₃/NiO | MoO₃/NiO | MoO₃/NiO |
| | | 10/2.1 | 10/2.1 | 10/2.1 | 10/2.1 | 10/2.1 | 10/2.1 |
| Specific surface area | m²/g | 152 | 167 | 170 | 163 | 179 | 105 |
| PV_{H2O} | ml/g | 0.80 | 0.74 | 0.72 | 0.77 | 0.75 | 0.71 |
| Pressure resistance strength | N/mm | 9.2 | 14.1 | 13.1 | 13.6 | 15.6 | 8.3 |
| Amount of P₂O₅ | mass % | 3.8 | 5.8 | 6.2 | 4.7 | 4.7 | 4.7 |
| Catalytic activity evaluation | | | | | | | |
| Demetallization rate | % | 79% | 76% | 73% | 77% | 72% | 83% |
| Desulfurization rate | % | 87% | 89% | 89% | 87% | 90% | 83% |
| Deasphaltene rate | % | 75% | 73% | 70% | 74% | 70% | 82% |

(*1) Local maximum PD: Pore diameter at which pore distribution becomes local maximum in the vicinity of 18 to 22 nm
(*2) ΔPV/PV_{T}: Volume of pores having a pore diameter deviating from local maximum PD ± 2 nm/total pore volume
(*3) Second peak: Presence or absence of a peak in pore distribution within a pore diameter range from 100 to 1,000 nm

### [Evaluation Results]

The results in Table 1 show that, since the catalysts A to D in the present invention have a predetermined configuration, the values of the demetallization rate and the deasphaltene rate are particularly higher than those of the catalysts E to I of Comparative Examples 1 to 5, and the desulfurization activity is also high.

The catalyst E of Comparative Example 1 is prepared from a carrier in which the pore size distribution has a predetermined configuration but phosphorus is not contained at a predetermined concentration, and thus has low pressure resistance strength and also has lower catalytic activity than the example catalysts. It can be seen that the catalyst F of Comparative Example 2 is prepared from a carrier containing phosphorus in an amount larger than the predetermined range, and the pore size distribution does not have a predetermined configuration in the present invention, resulting in low demetallization rate and deasphaltene rate.

The catalyst G of Comparative Example 3 is prepared from a carrier containing much more phosphorus than the catalyst F. The pore size distribution clearly does not meet the predetermined requirement of the present invention. Therefore, the demetallization rate and the deasphaltene rate are low.

In the catalyst H of Comparative Example 4, the amount of phosphorus is within the predetermined range of the present invention, but the pore size distribution does not meet the requirement of the present invention, and desired catalyst performance is not obtained. This reveals that the predetermined pore size distribution of the present invention is essential for improving the catalyst performance.

In the catalyst I of Comparative Example 5, although the amount of phosphorus is within the predetermined range of the present invention, the preparation of the carrier is started from the step of adding a basic aluminum salt solution to the base water, and the preparation does not follow the production method of the present invention. It is found that the pore size distribution clearly does not meet the predetermined requirement of the present invention, and the desired catalyst performance is not obtained.

The catalyst J of Comparative Example 6 was obtained by setting the calcining temperature when the molded product is calcined to obtain the carrier to 1050° C. in the method for producing the catalyst I of Comparative Example 5, and the pore size distribution satisfies the predetermined range of the present invention, but the crystalline form of alumina is different from the predetermined crystalline form of the present invention. The catalyst J has clearly low pressure resistance strength and also has a lower desulfurization rate than the example catalysts.

1. A heavy hydrocarbon oil hydrotreating catalyst
comprising an alumina-phosphorus oxide carrier, and a hydrogenation-active metal component supported on the carrier, wherein
the content of phosphorus in the carrier is 0.4 to 2.0 mass % in terms of P₂O₅,
the carrier has a local maximum value of the differential pore volume distribution in a pore diameter range of 18 to 22 nm measured by mercury intrusion porosimetry,
in the carrier, the ratio (ΔPV/PV_{T}) of a volume (ΔPV) of pores having a pore diameter in a range deviating from a range of a pore diameter at the local maximum value±2 nm to the total pore volume (PV_{T}) measured by mercury intrusion porosimetry is 0.50 or less, and
the crystalline form of a portion of alumina in the alumina-phosphorus oxide carrier is γ-alumina.

2. The heavy hydrocarbon oil hydrotreating catalyst according to claim 1, wherein the differential pore volume distribution of the carrier is unimodal.

3. The heavy hydrocarbon oil hydrotreating catalyst according to claim 1, wherein the total pore volume (PV_{H2O}) measured by a pore-filling method with water is 0.65 to 1.00 ml/g.

4. The heavy hydrocarbon oil hydrotreating catalyst according to claim 1, wherein phosphorus is contained in an amount of 1.0 to 5.0 mass % in terms of P₂O₅.

5. The heavy hydrocarbon oil hydrotreating catalyst according to claim 1, wherein the hydrogenation-active metal component comprises at least one metal selected from a group 6 metal and a group 8 metal of the periodic table.

6. The heavy hydrocarbon oil hydrotreating catalyst according to claim 1, wherein the content of the hydrogenation-active metal component is 1 to 25 mass % in terms of an oxide of the metal contained in the hydrogenation-active metal component.

7. (canceled)

8. (canceled)

9. (canceled)
